(19) United States
(12) Patent Application Publication
(10) Pub. No.: US 2026/0036967 A1
(43) Pub. Date: Feb. 5, 2026

(54) SYSTEMS AND METHODS TO CREATE PROCESS MODELS FOR ASSETS IN A FACILITY

(71) Applicant: Honeywell International Inc., Charlotte, NC (US)

(72) Inventors: Viraj Srivastava, Bengaluru (IN); Murugesh Palanisamy, Bengaluru (IN)

(21) Appl. No.: 18/788,197

(22) Filed: Jul. 30, 2024

(51) Int. Cl. G05B 19/418; G05B 23/02

(52) U.S. Cl. CPC G05B 19/4184; G05B 23/0283

(57) ABSTRACT

Various embodiments described herein relate to systems and methods for creating process models for assets in a facility. In this regard, historical data associated with operations of a first asset in the facility is processed. Using the processed historical data, key performance indicators for the first asset is determined. The key performance indicators are fitted using one or more data fitting techniques. Then, performance curves for at least one asset different from the first asset is generated based on the fitting of the key performance indicators. A process model is then created using the performance curves for the at least one asset.

### TECHNICAL FIELD

The present disclosure relates generally to asset management in a facility, and more particularly to systems and methods to create process models for one or more assets in the facility.

### BACKGROUND

Generally, a facility (such as a building, a warehouse, an industrial plant, a factory, and/or the like) includes numerous assets or equipment. These assets often correspond to boilers, chillers, compressors, air handling units (AHUs), variable refrigerant flow (VRF) systems, pumps, and/or the like. On an average, such assets span for substantially long periods in the facility. That is, an asset can typically be operational in the facility for several years provided that it is under proper maintenance. For proper maintenance of the assets, it is required to have related information associated with the assets. That is, it is required to have information such as performance curves of assets, design specifications of assets, datasheets associated with assets, and/or the like. However, at times some of this information may be unavailable or may even become obsolete over time. For example, after 10 years of operation, an asset may come up to repair where design specifications and performance curves of that asset may be required to perform repair. After such a long duration, the facility may not have the required information. It may so happen that an OEM (Original Equipment Manufacturer) of the asset may also not have the required information as they might have stopped manufacturing of the asset, or the OEM may be inoperative as well. Under such scenarios where there is dearth of required information, asset maintenance becomes challenging. This often leads to missed opportunities of repairs, improper detection of decreased or inefficient performance of assets, lost chances of early detection of anomalies, and/or the like. With this, the assets may be inefficiently utilized that is, the assets may be under-utilized or over-utilized leading to unoptimized usage of the assets in the facility.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an implementation of a controller that may execute techniques in accordance with one or more example embodiments described herein.

FIG. 3 illustrates a schematic diagram showing an implementation of an exemplary model generating system, in accordance with one or more example embodiments described herein.

FIG. 4 illustrates a flowchart showing a method described in accordance with one or more example embodiments described herein.

FIG. 5 illustrates a flowchart showing a method described in accordance with one or more example embodiments described herein.

FIG. 6 illustrates a flowchart showing a method described in accordance with one or more example embodiments described herein.

FIG. 7 illustrates a flowchart showing a method described in accordance with one or more example embodiments described herein.

FIG. 8 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for creating one or more process models for one or more assets in a facility is described herein. In this regard, the method comprises processing historical data associated with operations of a first asset of the one or more assets in the facility. The method then comprises determining one or more key performance indicators for the first asset based on the processing of the historical data. Further, the method comprises fitting the one or more key performance indicators using one or more data fitting techniques. Furthermore, the method comprises generating one or more performance curves for at least one asset of the one or more asset based on the fitting of the one or more key performance indicators. It is to be noted that the at least one asset is different from the first asset. Also, the method comprises creating a process model for the at least one asset based on the one or more performance curves.

In accordance with another embodiment of the current disclosure, a system for creating one or more process models for one or more assets in a facility is described herein. The system comprises a processor and a memory communicatively coupled to the processor, wherein the memory comprises one or more instructions which when executed by the processor, cause the processor to process historical data associated with operations of a first asset of the one or more assets in the facility. The processor is also configured to determine one or more key performance indicators for the first asset based on the processing of the historical data. Further, the processor is configured to fit the one or more key performance indicators using one or more data fitting techniques. Also, the processor is then configured to generate one or more performance curves for at least one asset of the one or more asset based on the fitting of the one or more key performance indicators. It is to be noted that the at least one asset is different from the first asset. Furthermore, the processor is also configured to create a process model for the at least one asset based on the one or more performance curves.

In accordance with yet another embodiment of the current disclosure, a non-transitory, computer-readable storage medium having instructions stored thereon and executable by one or more processors is described herein. In this regard, the instructions when executed by one or more processors cause the one or more processors to process historical data associated with operations of a first asset of one or more assets in a facility. The one or more processors are also configured to determine one or more key performance indicators for the first asset based on the processing of the historical data. Further, the one or more processors are also configured to fit the one or more key performance indicators using one or more data fitting techniques. Furthermore, the one or more processors are also configured to generate one or more performance curves for at least one asset of the one or more asset based on the fitting of the one or more key performance indicators. It is to be noted that the at least one asset is different from the first asset. Also, the one or more processors is further configured to create a process model for the at least one asset based on the one or more performance curves.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

Often, details or information associated with each of several assets in a facility is required to appropriately maintain the assets in the facility. The information may correspond to performance curves of assets, design specifications of assets, datasheets associated with assets, and/or the like. This information is often represented as process model(s) for the assets in the facility. At times, subject matter experts/technical experts in the facility spend substantial time in manually modelling the information as the process model(s). However, this manual modelling is often prone to errors as huge volume of information related to the assets needs to be manually processed and modelled. Also, at times all of the information may not be readily available to create process model(s). For example, some of the performance curves of certain assets may not be provided by OEMs or OEMs may not have relevant performance curves for certain assets. Due to this, appropriate process model(s) may be unavailable for certain assets in the facility impacting overall maintenance operations of the assets in the facility.

Mostly, the information associated with the assets is provided by OEMs (Original Equipment Manufacturers) of corresponding assets say, at the time of purchase of the said assets. It is to be noted that generally new assets operate close to maximum performance that is specified by OEMs and with minimal issues as well. Given that the assets normally span for several years in the facility, after substantial or long duration of operations in the facility, performance of the assets often decreases due to ageing/natural degradation. And there can be several reasons for such hindered performance of the assets in the facility. For example, performance of assets often decreases with time especially due to continuous rotating operations, and this generally happens with those assets that involve rotating components that is, assets such as compressors, turbines, pumps, and/or the like. In another example, assets may be subjected to overhauling or restoration when subjected to repairs impacting its normal/best performance. Yet in another example, assets may be operated at different conditions than its design conditions hampering its normal/best performance. In such instances where performance of the assets decreases, at least some of the information such as performance curves provided by OEMs may be no longer applicable to assess performance of the assets. This is because the performance curves provided by OEMs apply when the assets operate at their normal/best performance as the performance curves are generated considering normal/best performance of the assets. So, when the performance of certain assets decreases, such performance curves may become redundant. With this, a baseline performance for certain assets becomes absent. Due to this, it becomes challenging to determine whether a current performance of an asset has further degraded or not. This further leads to missed opportunities of repairs, lost chances of early detection of anomalies, and/or the like for the asset. With all of these constraints, asset management becomes challenging in the facility.

Thus, to address the above challenges, various example embodiments of systems and methods described herein facilitate creation of process models for assets in a facility. In this regard, for instance, the system described herein is configured to generate at least some of information related to the assets in the facility. That is, the system described herein generates information such as performance curves for at least one asset in the facility. Using the performance curves, the system further creates a process model for the at least one asset. The process models often represent the information associated with the assets. Such process models can be used for regular maintenance and monitoring of the assets in the facility. Initially, the system described herein is configured to process historical data associated with operations of an asset (say, a first asset) of one or more assets in the facility. Also, it is to be noted that the system processes historical data associated with other related assets as well. The historical data is associated with operations of the first asset between a specific timeframe. This timeframe may correspond to normal operations of the first asset in the facility. In some instances, customers or personnel associated with the facility may provide the historical data. For processing the historical data, the system described herein is configured to identify data such as tags specific to pressure, temperature, speed, and/or the like from the historical data. Then, the historical data is cleansed after identification of tags. That is, unwanted/inconsistent data tags are removed from the historical data as a part of cleansing. After such processing of the historical data, the system determines one or more key performance indicators for the first asset based on the processing of the historical data. To determine the one or more key performance indicators, the system considers the one or more tags specific to pressure, temperature, speed, and/or the like from the historical data. The system applies techniques such as, first principal equations (e.g. thermal and mass balance equations) on the one or more tags of the historical data. Based on the application of said techniques, the system derives the one or more key performance indicators. These key performance indicators may correspond to thermodynamic key performance indicators such as polytropic head, power, efficiency, and/or the like.

The system then performs fitting of the one or more key performance indicators using one or more data fitting techniques. In this regard, the system utilizes one or more data models with appropriate learning mechanisms that is, the one or more data fitting techniques to appropriately fit the one or more key performance indicators as curves. Upon fitting the one or more key performance indicators, the system generates one or more performance curves for at least one asset of the one or more asset. The at least one asset is different from the first asset whose historical data is processed by the system but the at least one asset may have or share common characteristics with the said first asset. For example, both assets: may be of same category, may share similar components, may be used in similar processes in the facility, may have similar process parameters, may or may not be affected by operating conditions, may be identical, and/or the like. In view of such similarities, the system generates the one or more performance curves for the at least one asset using historical data associated with the first asset. Using the one or more performance curves, a process model for the at least one asset is created. The process model along with the performance curves may be used in the facility to monitor operations of the at least one asset. The process model can also be used to monitor operations of other identical assets as well. For instance, personnel such as operators in the facility may use the process model to monitor operational performance of assets similar to the at least one asset for which the process model is created. In another instance, the facility may provide the process model to a customer or OEMs of respective assets. This facilitates re-usability of process models for certain assets in the facility. In scenarios where there is dearth of performance curves especially for those assets with rotating components, the system described herein automatically creates process models along with performance curves in just a short span of time.

Also, the system described herein uses created process models for further creating other process models for different set of assets considering the said similarity factors as well. In this regard, a user such as personnel or customer(s) may just provide an identifier of a process model. Based on the identifier, the system retrieves appropriate process model(s). The user may further provide one or more specifications based on which retrieved process model(s) are used to create the other process models. With this, the system described herein facilitates automated creation of process models for the assets in the facility irrespective of lack of relevant information for the assets in the facility. With this, the assets in the facility can be often monitored for performance as baseline values of performance can be generated based on current statuses of the assets and as per requirements. This makes sure that need for maintenance is accurately predicted in a timely manner along with early detection of faults based on current performances of the assets in the facility. This significantly saves time and resources in the facility along with efficient utilization of the assets in the facility.

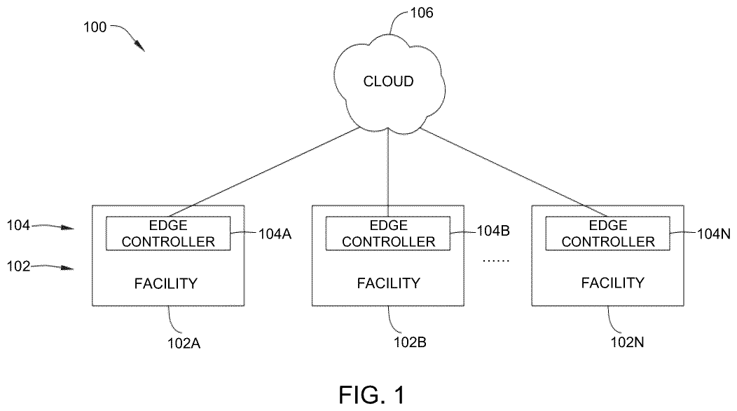

FIG. 1 illustrates a schematic diagram showing an exemplary environment comprising multiple facilities. According to various example embodiments described herein, an exemplary environment 100 comprises one or more facilities 102a, 102b, . . . 102n (collectively “facilities 102”). In some example embodiments, a facility of the one or more facilities 102a, 102b, . . . 102n may correspond to, for example, a building, a factory, an industry, a material handling environment, a warehouse, a supply chain environment, an industrial plant, a manufacturing facility, and/or the like. In some example embodiments, the one or more facilities 102a, 102b, . . . 102n in the illustrative environment 100 may be of same type. In some example embodiments, the one or more facilities 102a, 102b, . . . 102n in the illustrative environment 100 may be of different type. As it may be understood, in some example embodiments described herein, a facility of the one or more facilities 102a, 102b, . . . 102n often employs several assets to facilitate numerous operations in the facility. For appropriate maintenance of such fleet of assets, all relevant information associated with the assets is required. In this regard, the facility often gathers and maintains relevant information associated with the assets for instance, in a database or in a repository. The information generally corresponds to performance curves, data sheets, design specifications, and/or the like. The facilities 102 described herein use such information to automatically create one or more process models for corresponding assets. In this regard, the one or more process models described herein are used to maintain and manage the assets in each of the respective facilities 102.

In some example embodiments, a cloud 106 is operably coupled with one or more facilities 102a, 102b, . . . 102n, meaning that communication between the cloud 106 and one or more facilities 102a, 102b, . . . 102n is enabled. The cloud 106 may represent distributed computing resources, software, platform or infrastructure services which can enable data handling, data processing, data management, and/or analytical operations on the data exchanged & transacted in the facilities 102. In some example embodiments described herein, the cloud 106 represents a platform that comprises one or more services to facilitate asset management and/or overall facility management as well. Per this aspect, the one or more services of the cloud 106 appropriately handle, process, and/or manage the data at the cloud 106. This data may correspond to the information associated with the assets in the facility. That is, performance curves, data sheets, design specifications, and/or the like associated with one or more assets in the facility. At least some of the information may be provided by users such as personnel and customers associated with the facility along with OEMs of respective assets in the facility. Also, the cloud 106 may include and/or generate the one or more process models using such information from a respective facility of the facilities 102. In some example embodiments, the cloud 106 includes one or more servers that may be programmed to communicate with the one or more facilities 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

Each of the facilities 102 may include a variety of operations. In this regard, the assets in each of the facilities 102 may be humongous in number and diverse as well. For instance, the facility may include wide range of assets such as boilers, chillers, air handling units (AHUs), variable air volumes (VAVs), pipes, compressors, pumps, sensors, turbines, and/or the like to support various operations in the facility. In some example embodiments, the cloud 106 may manage and/or control respective assets in the facilities 102 using the one or more process models. In this regard, in the example shown in FIG. 1, each of the one or more facilities 102a, 102b, . . . 102n includes a respective edge controller (alternatively, edge gateway) 104a, 104b, . . . 104n (collectively “edge controllers 104” or “edge gateways 104”). In some example embodiments, each of one or more edge controllers 104a, 104b, . . . 104n is configured to receive the data from the respective facilities 102. In some example embodiments, the assets may provide the necessary data to a respective edge controller in the respective facility. In some examples, the one or more edge controllers 104a, 104b, . . . 104n may operate as intermediary node to transact the data between the facilities 102 and/or the cloud 106. In this regard, the data includes performance curves, design specifications, data sheets, and/or like associated with the assets in the facilities 102. Additionally, the data also includes metadata and/or other relevant data (for example, operational data such as telemetry data in real time, near-real time, and/or historical time) associated with the assets in the facilities 102. In some examples, each of the one or more edge controllers 104a, 104b, . . . 104n is capable of receiving the data from disparate data sources in different data formats and/or using various data communication protocols, from the facilities 102. In this regard, each of the one or more edge controllers 104a, 104b, . . . 104n can receive & filter the data and translate the data into a common language and/or format (e.g. normalized data) for subsequent communication to the cloud 106. The common language and/or format may be compatible with and expected by the cloud 106.

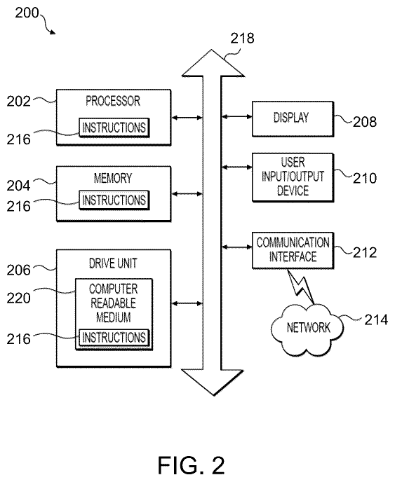

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

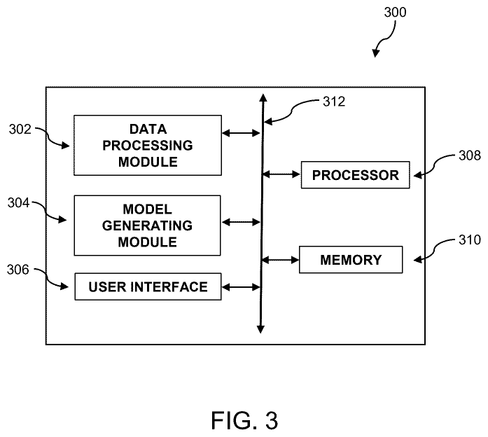

FIG. 3 illustrates a schematic diagram showing an implementation of an exemplary model generating system, in accordance with one or more example embodiments described herein. In one or more example embodiments, the model generating system 300 is configured to create one or more process models for one or more assets in a facility. (for instance, one or more facilities 102a, 102b, . . . 102n as described in FIG. 1 of the current disclosure). Generally, the facility maintains a storage or a repository of all relevant information associated with the one or more assets in the facility. The information often corresponds to performance curves of assets, design specifications of assets, datasheets associated with assets, and/or the like. With this, the facility makes sure that all required information to manage and monitor the assets is available. However, at times, the information may not be up to date as some information might be missing. Further, at least some of the information may be redundant or irrelevant as well. For example, certain performance curves and/or design specifications provided by OEMs may be redundant for an asset as the asset might have undergone significant overhauling or restoration. Due to such mutation, performance curves and/or design specifications provided by the OEMs may be no longer applicable to the asset. With this, performance curves and/or design specifications provided by the OEMs for the asset may be of no use. In another example, the facility and/or the OEMs may not have required performance curves. Yet in another example, due to ageing, at least some of the assets may naturally tend to lose some original characteristics such as best performance, efficiency, and/or the like due to which some information for such assets becomes irrelevant. Under such scenarios where there is dearth of information and/or irrelevant information is present, the model generating system 300 described herein generates relevant information such as performance curves for the one or more assets in the facility. The generated performance curves along with other relevant information associated with the assets are then represented as the one or more process models. Such process models are used to manage and monitor the assets in the facility as they comprise all required information based on current scenarios and/or requirements of the assets in the facility.

In some example embodiments, the model generating system 300 is a server system (e.g., a server device) that facilitates a data analytics platform between one or more computing devices, one or more data sources, and/or one or more facilities. In some example embodiments, the model generating system 300 is a device with one or more processors and a memory. Also, in some example embodiments, the model generating system 300 is implementable via the cloud 106. The model generating system 300 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the model generating system 300 comprises one or more components such as, a data processing module 302, a model generating module 304, and/or a user interface 306. Additionally, in one or more example embodiments, the model generating system 300 comprises a processor 308 and/or a memory 310. In one or more example embodiments, one or more components of the model generating system 300 may be communicatively coupled to processor 308 and/or a memory 310 via a bus 312. In certain example embodiments, one or more aspects of the model generating system 300 (and/or other systems, apparatuses and/or processes disclosed herein) constitute executable instructions embodied within a computer-readable storage medium (e.g., the memory 310). For instance, in an example embodiment, the memory 310 stores computer executable component and/or executable instructions (e.g., program instructions). Furthermore, the processor 308 facilitates execution of the computer executable components and/or the executable instructions (e.g., the program instructions). In an example embodiment, the processor 308 is configured to execute instructions stored in the memory 310 or otherwise accessible to the processor 308.

The processor 308 is a hardware entity (e.g., physically embodied in circuitry) capable of performing operations according to one or more embodiments of the disclosure. Alternatively, in an example embodiment where the processor 308 is embodied as an executor of software instructions, the software instructions configure the processor 308 to perform one or more algorithms and/or operations described herein in response to the software instructions being executed. In an example embodiment, the processor 308 is a single core processor, a multi-core processor, multiple processors internal to the model generating system 300, a remote processor (e.g., a processor implemented on a server), and/or a virtual machine. In certain example embodiments, the processor 308 is in communication with the memory 310, the data processing module 302, the model generating module 304, and/or the user interface 306 via the bus 312 to, for example, facilitate transmission of data between the processor 308, the memory 310, the data processing module 302, the model generating module 304, and/or the user interface 306. In some example embodiments, the processor 308 may be embodied in a number of different ways and, in certain example embodiments, includes one or more processing devices configured to perform independently. Additionally or alternatively, in one or more example embodiments, the processor 308 includes one or more processors configured in tandem via bus 312 to enable independent execution of instructions, pipelining of data, and/or multi-thread execution of instructions.

The memory 310 is non-transitory and includes, for example, one or more volatile memories and/or one or more non-volatile memories. In other words, in one or more example embodiments, the memory 310 is an electronic storage device (e.g., a computer-readable storage medium). The memory 310 is configured to store information, data, content, one or more applications, one or more instructions, or the like, to enable the model generating system 300 to carry out various functions in accordance with one or more embodiments disclosed herein. In accordance with some example embodiments described herein, the memory 310 may correspond to an internal or external memory of the model generating system 300. In some examples, the memory 310 may correspond to a database communicatively coupled to the model generating system 300. As used herein in this disclosure, the term “component,” “system,” “module”, and/or the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the data processing module 302 is configured to process historical data associated with operations of an asset (say, a first asset) of the one or more assets in the facility. In this regard, the historical data corresponds to operational data associated with the first asset. The operational data comprises data such as one or more operating points of the asset when in operation. For example, the operational data comprises one or more measurements of flow rate, speed, power, polytropic head, pressure, temperature, and/or the like. Also, it is to be noted that the operational data alternatively corresponds to telemetry data received from the first asset. In this regard, the telemetry data corresponds to data received from the first asset in real time, near-real time, and/or historical time. Such data may be stored in a repository or a database. In some instances, the historical data may be provided by one or more users such as personnel and/or customers associated with the facility as well. The data processing module 302 retrieves and processes such historical data associated with the operations of the first asset over a specific period of time. That is, the data processing module 302 processes the operational data between specific timeframes. The said timeframe may be defined based on need basis by one or more users such as personnel and/or customers associated with the facility. Also, the timeframe may be chosen based on an operating condition of the asset. For example, personnel may choose a timeframe in historical data for which an asset was in normal operating condition. In another instance, a timeframe may be chosen in historical data once an asset operates upon overhauling. Additionally, the data processing module 302 also considers other historical data associated with other assets similar to the first asset while processing the historical data. For example, while the data processing module 302 processes historical data associated with a compressor for a first timeframe, the data processing module 302 may also consider historical data associated with ten other compressors for processing as well.

Further, with regards to processing the historical data, the data processing module 302 is initially configured to identify one or more tags from the historical data. The one or more tags may be, but not limited to tags specific to pressure, temperature, speed, and/or the like identified out of the historical data. In this regard, the data processing module 302 identifies and classifies one or more measurements in the historical data under specific tags. Upon identification of such tags, the data processing module 302 cleanses the one or more tags. That is, the data processing module 302 determines if at least one tag of the one or more tags comprises inconsistent data. For instance, some of the tags may have redundant or incorrect or bad values. Tags with such inconsistent data is identified by the data processing module 302. The data processing module 302 may comprise various criteria such as thresholds, rules, and/or the like to determine if the at least one tag comprises inconsistent data. Then, the data processing module 302 removes the at least one tag from the one or more tags if the at least one tag comprises inconsistent data. The resultant data corresponds to processed historical data which is cleansed for redundant data tags. Said alternatively, the data processing module 302 derives the processed historical data based on the removal of the at least one tag. The data processing module 302 then transmits the processed historical data to the model generating module 304 for further analysis.

In one or more example embodiments, the model generating module 304 determines one or more key performance indicators for the first asset using the processed historical data. These key performance indicators may correspond to thermodynamic key performance indicators such as polytropic head, power, speed, flow rate, efficiency, and/or the like. To determine the one or more key performance indicators, the model generating module 304 applies techniques such as, one or more first principle equations on one or more tags in the processed historical data. For example, the model generating module 304 applies first principle equations such as thermal and mass balance equations on the processed historical data to derive some of the key performance indicators. Then, based on the application of the one or more first principle equations, the model generating module 304 converts the one or more tags in the processed historical data to the said one or more key performance indicators. Further, in one or more example embodiments, the model generating module 304 fits the one or more key performance indicators using one or more data fitting techniques. In this regard, the model generating module 304 utilizes one or more data models with data fitting mechanisms/techniques to fit the one or more key performance indicators. That is, the one or more key performance indicators are processed using the one or more data fitting techniques in the one or more data models. The model generating module 304 then reduces the one or more key performance indicators to non-dimensionalize the one or more key performance indicators. That is, the model generating module 304 uses one or more laws such as Buckingham PI theorem, one or more modified fan laws, and/or the like to non-dimensionalize the one or more key performance indicators. More particularly, the model generating module 304 applies Buckingham PI theorem to transform the one or more key performance indicators to one or more non-dimensional variables. Then, the model generating module 304 applies one or more modified fan laws on the one or more non-dimensional variables to transform the one or more non-dimensional variables to one or more reduced coordinates. The one or more reduced coordinates correspond to the one or more reduced key performance indicators. Furthermore, the model generating module 304 then fits the one or more reduced key performance indicators along one or more curves. That is, the one or more reduced coordinates are fit along the one or more curves using the one or more data fitting techniques in the one or more data models.

Then, in one or more example embodiments described herein, the model generating module 304 generates the one or more performance curves for at least one asset of the one or more assets. In this regard, the at least one asset is different from the first asset. To generate the one or more performance curves, the model generating module 304 initially determines if the at least one asset is similar to the first asset. This determination is based on consideration of one or more similarity factors by the model generating module 304. The one or more similarity factors may be, but not limited to similarity in at least one of: category of assets, one or more components used in the assets, one or more processes handled by the assets, one or more process parameters of the assets, one or more operating conditions of the assets, and/or the like. For example, if the first asset and the at least one asset are compressors, then the model generating module 304 determines that the first asset and the at least one asset fall under same category of compressor devices. In another example, if both of the first asset and the at least one asset comprise either of components such as compressor lube oil subsystem, gland steam seal system, condenser subsystem, and/or the like in common, then the model generating module 304 derives similarity between the assets based on such common components. Yet in another example, if both of the first asset and the at least one asset are installed in similar environments in the facility, then the model generating module 304 derives similarity between the assets based on the similarity in the operating environments. Also, in another example, the model generating module 304 determines similarity between the assets based on an impact/a non-impact of the operating conditions and/or environments on respective assets.

Further, the model generating module 304 derives one or more geometrical coordinates and one or more coefficients for the at least one asset. These geometrical coordinates and coefficients are derived based on reduced key performance indicators along with one or more curves, and similarity between the at least one asset and the first asset. That is, upon determining that the at least one asset and the first asset are similar, the model generating module 304 uses the one or more reduced coordinates along the one or more curves to derive the geometrical coordinates and coefficients for the at least one asset. Considering the geometrical coordinates and coefficients, the model generating module 304 creates the one or more performance curves for the at least one asset. In this regard, creation of the one or more performance curves for the at least one asset facilitates re-usability of data associated with the first asset and is useful when there is dearth of performance curves for assets in the facility. The one or more performance curves can also be rendered via the user interface 306 for instance, which may correspond to a display of a mobile device or a computing device (not shown). With this, one or more users such as operators/personnel in the facility can view the one or more performance curves.

Also, in one or more example embodiments, the model generating module 304 creates a process model for the at least one asset based on the one or more performance curves. In one or more example embodiments, the process model is used by the model generating module 304 to monitor performance of the at least one asset. Then, based on the monitoring, the model generating module 304 determines if the performance of the at least one asset is below a pre-defined threshold. If the model generating module 304 determines that the performance of the at least one asset is below the pre-defined threshold, the model generating module 304 provides one or more recommendations for the at least one asset. In this regard, the one or more recommendations may be, but not limited to one or more preventive actions such as predictions for maintenance, early detection of faults and remedial actions for same, and/or the like to be taken for the at least one asset. Additionally, it is to be noted that the model generating module 304 also monitors other assets similar to that of the at least one asset using the process model created for the at least one asset. Also, such process models are stored in the database/repository for later usage as well. In this regard, each of the process models may be provided with an identifier and stored. For instance, when users such as personnel or customers associated with the facility provide an identifier of a process model, the model generating system 300 retrieves the appropriate process model. Also, in one or more example embodiments, the model generating module 304 described herein uses created process models for further creating other process models for different set of assets considering the said similarity factors as well. The created process models and the performance curves acts as baseline against which current performances of the assets can be measured. With this, the assets in the facility can be monitored for performance as baseline values of performance can be generated based on current statuses of the assets and as per requirements. This makes sure that need for maintenance is accurately predicted in a timely manner along with early detection of faults based on current performances of the assets in the facility. This significantly saves time and resources in the facility along with efficient utilization of the assets in the facility.

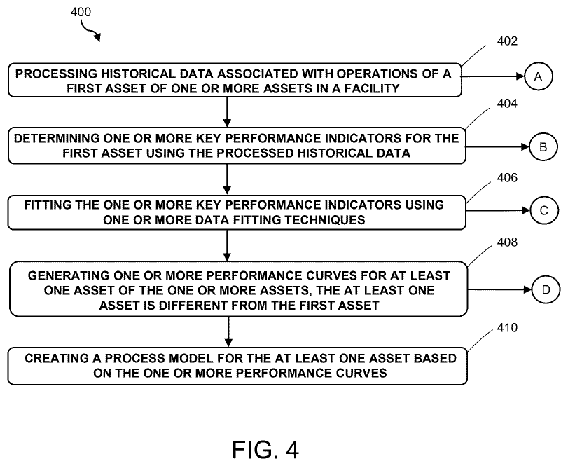

FIG. 4 illustrates a flowchart showing a method described in accordance with one or more example embodiments described herein. In this regard, FIG. 4 illustrates operations that may be performed by the model generating system 300. In some embodiments, the example method 400 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 400. At step 402 of the exemplary flowchart 400, the model generating system 300 comprises means such as, the data processing module 302 to process historical data associated with operations of a first asset of one or more assets in a facility. Then, at step 404 of the exemplary flowchart 400, the model generating system 300 comprises means such as, the model generating module 304 to determine one or more key performance indicators for the first asset using the processed historical data. At step 406 of the exemplary flowchart 400, the model generating system 300 comprises means such as, the model generating module 304 to fit the one or more key performance indicators using one or more data fitting techniques. At step 408 of the exemplary flowchart 400, the model generating system 300 comprises means such as, the model generating module 304 to generate one or more performance curves for at least one asset of the one or more assets. In this regard, the at least one asset is different from the first asset. At step 410 of the exemplary flowchart 400, the model generating system 300 comprises means such as, the model generating module 304 to create a process model for the at least one asset based on the one or more performance curves.

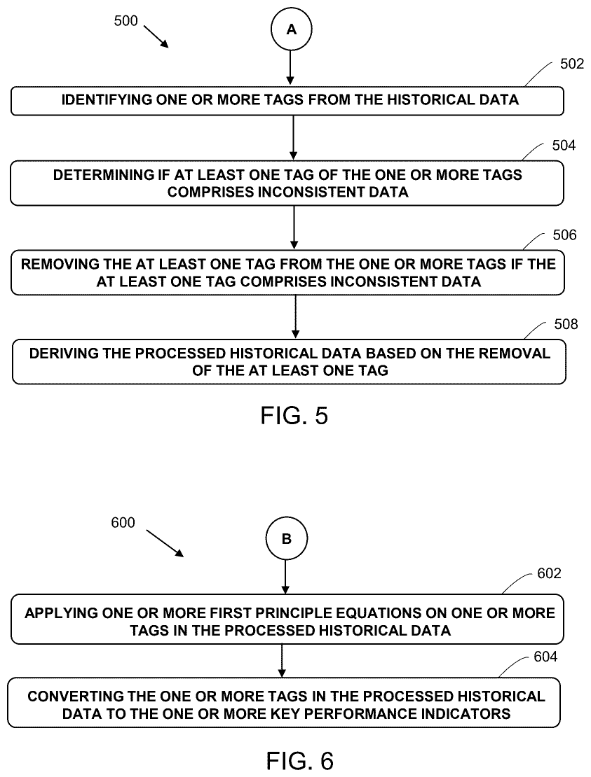

FIG. 5 illustrates a flowchart showing a method described in accordance with one or more example embodiments described herein. In this regard, FIG. 5 illustrates operations that may be performed by the model generating system 300. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500. At step 502 of the exemplary flowchart 500, the model generating system 300 comprises means such as, the data processing module 302 to identify one or more tags from the historical data. The one or more tags comprise at least one of: pressure data tags, temperature data tags, flow rate data tags, and speed data tags associated with the operations of the first asset. At step 504 of the exemplary flowchart 500, the model generating system 300 comprises means such as, the data processing module 302 to determine if at least one tag of the one or more tags comprises inconsistent data. At step 506 of the exemplary flowchart 500, the model generating system 300 comprises means such as, the data processing module 302 to remove the at least one tag from the one or more tags if the at least one tag comprises inconsistent data. At step 508 of the exemplary flowchart 500, the model generating system 300 comprises means such as, the data processing module 302 to derive the processed historical data based on the removal of the at least one tag.

FIG. 6 illustrates a flowchart showing a method described in accordance with one or more example embodiments described herein. In this regard, FIG. 6 illustrates operations that may be performed by the model generating system 300. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600. At step 602 of the exemplary flowchart 600, the model generating system 300 comprises means such as, the model generating module 304 to apply one or more first principle equations on one or more tags in the processed historical data. At step 604 of the exemplary flowchart 600, the model generating system 300 comprises means such as, the model generating module 304 to convert the one or more tags in the processed historical data to the one or more key performance indicators. The one or more key performance indicators are related to thermodynamic key performance indicators, and the one or more key performance indicators correspond to at least one of: polytropic head, power, speed, flow rate, and efficiency associated with the first asset.

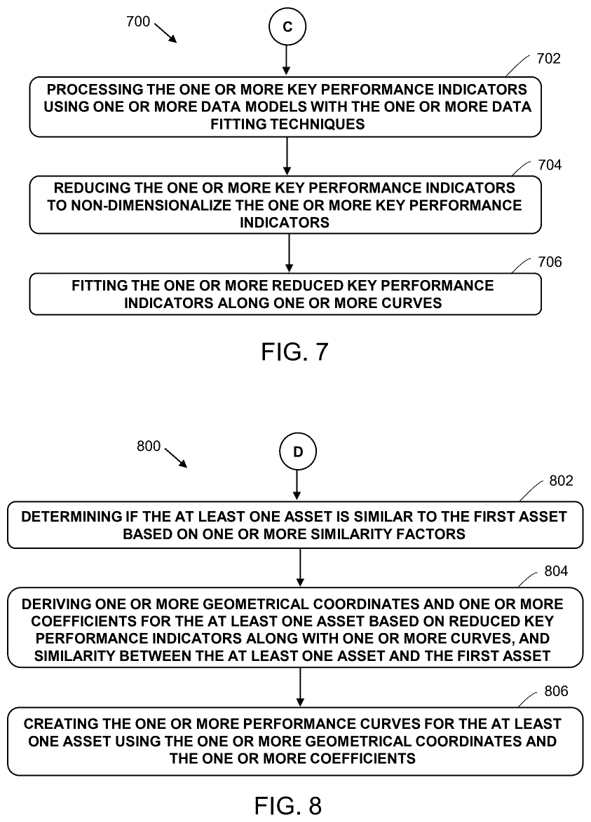

FIG. 7 illustrates a flowchart showing a method described in accordance with one or more example embodiments described herein. In this regard, FIG. 7 illustrates operations that may be performed by the model generating system 300. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700. At step 702 of the exemplary flowchart 700, the model generating system 300 comprises means such as, the model generating module 304 to process the one or more key performance indicators using one or more data models with the one or more data fitting techniques. At step 704 of the exemplary flowchart 700, the model generating system 300 comprises means such as, the model generating module 304 to reduce the one or more key performance indicators to non-dimensionalize the one or more key performance indicators. At step 706 of the exemplary flowchart 700, the model generating system 300 comprises means such as, the model generating module 304 to fit the one or more reduced key performance indicators along one or more curves.

FIG. 8 illustrates a flowchart showing a method described in accordance with one or more example embodiments described herein. In this regard, FIG. 8 illustrates operations that may be performed by the model generating system 300. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800. At step 802 of the exemplary flowchart 800, the model generating system 300 comprises means such as, the model generating module 304 to determine if the at least one asset is similar to the first asset based on one or more similarity factors. The one or more similarity factors are associated with similarity in at least one of: category of assets, one or more components used in the assets, one or more processes handled by the assets, one or more process parameters of the assets, and one or more operating conditions of the assets. At step 804 of the exemplary flowchart 800, the model generating system 300 comprises means such as, the model generating module 304 to derive one or more geometrical coordinates and one or more coefficients for the at least one asset based on reduced key performance indicators along one or more curves, and similarity between the at least one asset and the first asset. At step 806 of the exemplary flowchart 800, the model generating system 300 comprises means such as, the model generating module 304 to create the one or more performance curves for the at least one asset using the one or more geometrical coordinates and the one or more coefficients.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For case of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™M, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

1. A method for creating one or more process models for one or more assets in a facility, the method comprising:
processing historical data associated with operations of a first asset of the one or more assets in the facility;
determining one or more key performance indicators for the first asset using the processed historical data;
fitting the one or more key performance indicators using one or more data fitting techniques;
generating one or more performance curves for at least one asset of the one or more assets, wherein the at least one asset is different from the first asset; and
creating a process model for the at least one asset based on the one or more performance curves.

2. The method of claim 1, wherein processing the historical data associated with the operations of the first asset comprises:
identifying one or more tags from the historical data, wherein the one or more tags comprise at least one of: pressure data tags, temperature data tags, flow rate data tags, and speed data tags associated with the operations of the first asset;
determining if at least one tag of the one or more tags comprises inconsistent data;
removing the at least one tag from the one or more tags if the at least one tag comprises inconsistent data; and
deriving the processed historical data based on the removal of the at least one tag.

3. The method of claim 1, wherein determining the one or more key performance indicators for the first asset comprises:
applying one or more first principle equations on one or more tags in the processed historical data; and
converting the one or more tags in the processed historical data to the one or more key performance indicators, wherein the one or more key performance indicators are related to thermodynamic key performance indicators, and wherein the one or more key performance indicators correspond to at least one of: polytropic head, power, speed, flow rate, and efficiency associated with the first asset.

4. The method of claim 1, wherein fitting the one or more key performance indicators comprises:
processing the one or more key performance indicators using one or more data models with the one or more data fitting techniques;
reducing the one or more key performance indicators to non-dimensionalize the one or more key performance indicators; and
fitting the one or more reduced key performance indicators along one or more curves.

5. The method of claim 1, wherein generating the one or more performance curves for the at least one asset comprises:
determining if the at least one asset is similar to the first asset based on one or more similarity factors, wherein the one or more similarity factors are associated with similarity in at least one of: category of assets, one or more components used in the assets, one or more processes handled by the assets, one or more process parameters of the assets, and one or more operating conditions of the assets;
deriving one or more geometrical coordinates and one or more coefficients for the at least one asset based on reduced key performance indicators along one or more curves, and similarity between the at least one asset and the first asset; and
creating the one or more performance curves for the at least one asset using the one or more geometrical coordinates and the one or more coefficients.

6. The method of claim 1, further comprising rendering, on a display, the one or more performance curves for the at least one asset.

7. The method of claim 1, further comprising:
monitoring performance of the at least one asset using the process model;
determining if the performance of the at least one asset is below a pre-defined threshold; and
providing one or more recommendations for the at least one asset if the performance of the at least one asset is below the pre-defined threshold, wherein the one or more recommendations correspond to one or more preventive actions to be taken for the at least one asset.

8. A system for creating one or more process models for one or more assets in a facility, the system comprising:
a processor;
a memory communicatively coupled to the processor, wherein the memory comprises one or more instructions which when executed by the processor, cause the processor to:
process historical data associated with operations of a first asset of the one or more assets in the facility;
determine one or more key performance indicators for the first asset using the processed historical data;
fit the one or more key performance indicators using one or more data fitting techniques;
generate one or more performance curves for at least one asset of the one or more assets, wherein the at least one asset is different from the first asset; and
create a process model for the at least one asset based on the one or more performance curves.

9. The system of claim 8, wherein the processor is further configured to:
identify one or more tags from the historical data, wherein the one or more tags comprise at least one of: pressure data tags, temperature data tags, flow rate data tags, and speed data tags associated with the operations of the first asset;
determine if at least one tag of the one or more tags comprises inconsistent data;
remove the at least one tag from the one or more tags if the at least one tag comprises inconsistent data; and
derive the processed historical data based on the removal of the at least one tag.

10. The system of claim 8, wherein the processor is further configured to:
apply one or more first principle equations on one or more tags in the processed historical data; and
convert the one or more tags in the processed historical data to the one or more key performance indicators, wherein the one or more key performance indicators are related to thermodynamic key performance indicators, and wherein the one or more key performance indicators correspond to at least one of: polytropic head, power, speed, flow rate, and efficiency associated with the first asset.

11. The system of claim 8, wherein the processor is further configured to:
process the one or more key performance indicators using one or more data models with the one or more data fitting techniques;
reduce the one or more key performance indicators to non-dimensionalize the one or more key performance indicators; and
fit the one or more reduced key performance indicators along one or more curves.

12. The system of claim 8, wherein the processor is further configured to:
determine if the at least one asset is similar to the first asset based on one or more similarity factors, wherein the one or more similarity factors are associated with similarity in at least one of: category of assets, one or more components used in the assets, one or more processes handled by the assets, one or more process parameters of the assets, and one or more operating conditions of the assets;
derive one or more geometrical coordinates and one or more coefficients for the at least one asset based on reduced key performance indicators along one or more curves, and similarity between the at least one asset and the first asset; and
create the one or more performance curves for the at least one asset using the one or more geometrical coordinates and the one or more coefficients.

13. The system of claim 8, wherein the processor is further configured to render, on a display, the one or more performance curves for the at least one asset.

14. The system of claim 8, wherein the processor is further configured to:
monitor performance of the at least one asset using the process model;
determine if the performance of the at least one asset is below a pre-defined threshold; and
provide one or more recommendations for the at least one asset if the performance of the at least one asset is below the pre-defined threshold, wherein the one or more recommendations correspond to one or more preventive actions to be taken for the at least one asset.

15. A non-transitory, computer-readable storage medium having stored thereon executable instructions that, when executed by one or more processors, cause the one or more processors to:
process historical data associated with operations of a first asset of one or more assets in a facility;
determine one or more key performance indicators for the first asset using the processed historical data;
fit the one or more key performance indicators using one or more data fitting techniques;
generate one or more performance curves for at least one asset of the one or more assets, wherein the at least one asset is different from the first asset; and
create a process model for the at least one asset based on the one or more performance curves.

16. The non-transitory, computer-readable storage medium of claim 15, wherein the one or more processors is further configured to:
identify one or more tags from the historical data, wherein the one or more tags comprise at least one of: pressure data tags, temperature data tags, flow rate data tags, and speed data tags associated with the operations of the first asset;
determine if at least one tag of the one or more tags comprises inconsistent data;
remove the at least one tag from the one or more tags if the at least one tag comprises inconsistent data; and
derive the processed historical data based on the removal of the at least one tag.

17. The non-transitory, computer-readable storage medium of claim 15, wherein the one or more processors is further configured to:
apply one or more first principle equations on one or more tags in the processed historical data; and
convert the one or more tags in the processed historical data to the one or more key performance indicators, wherein the one or more key performance indicators are related to thermodynamic key performance indicators, and wherein the one or more key performance indicators correspond to at least one of: polytropic head, power, speed, flow rate, and efficiency associated with the first asset.

18. The non-transitory, computer-readable storage medium of claim 15, wherein the one or more processors is further configured to:
process the one or more key performance indicators using one or more data models with the one or more data fitting techniques;
reduce the one or more key performance indicators to non-dimensionalize the one or more key performance indicators; and
fit the one or more reduced key performance indicators along one or more curves.

19. The non-transitory, computer-readable storage medium of claim 15, wherein the one or more processors is further configured to:
determine if the at least one asset is similar to the first asset based on one or more similarity factors, wherein the one or more similarity factors are associated with similarity in at least one of:
category of assets, one or more components used in the assets, one or more processes handled by the assets, one or more process parameters of the assets, and one or more operating conditions of the assets;
derive one or more geometrical coordinates and one or more coefficients for the at least one asset based on reduced key performance indicators along one or more curves, and similarity between the at least one asset and the first asset; and
create the one or more performance curves for the at least one asset using the one or more geometrical coordinates and the one or more coefficients.

20. The non-transitory, computer-readable storage medium of claim 15, wherein the one or more processors is further configured to:
monitor performance of the at least one asset using the process model;
determine if the performance of the at least one asset is below a pre-defined threshold; and
provide one or more recommendations for the at least one asset if the performance of the at least one asset is below the pre-defined threshold, wherein the one or more recommendations correspond to one or more preventive actions to be taken for the at least one asset.
